(19) United States
(12) Patent Application Publication
(10) Pub. No.: US 2024/0169484 A1
(43) Pub. Date: May 23, 2024

(54) METHOD AND APPARATUS FOR NON-UNIFORM SUPER-RESOLUTION OF IMAGE

(71) Applicant: Electronics and Telecommunications Research Institute, Daejeon (KR)

(72) Inventors: Sang Woon KWAK, Daejeon (KR); Han Shin LIM, Daejeon (KR); Hyon Gon CHOO, Daejeon (KR)

(73) Assignee: Electronics and Telecommunications Research Institute, Daejeon (KR)

(21) Appl. No.: 18/514,150

(22) Filed: Nov. 20, 2023

(30) Foreign Application Priority Data
Nov. 21, 2022 (KR) 10-2022-0156344
Nov. 13, 2023 (KR) 10-2023-0156798

(51) Int. Cl. G06T 3/40; G06T 5/00; G06T 5/50; G06T 7/00; G06T 7/11; G06V 10/771

(52) U.S. Cl. CPC G06T 3/4053; G06T 5/002; G06T 5/50; G06T 7/0002; G06T 7/11; G06V 10/771; G06T 2207/20221; G06T 2207/30168

(57) ABSTRACT

A non-uniform super-resolution method, device, and recording medium of an image of the present disclosure may include an image separation unit which separates an input image into a high-quality region and a low-quality region based on a quality map image, an image quality conversion unit which acquires a converted high-quality region by converting image quality of the high-quality region, and a first image combination unit which combines the converted high-quality region and the low-quality region to transmit them to a super-resolution network.

### CROSS-REFERENCE TO RELATED APPLICATIONS

This application claims the benefit of earlier filing date and right of priority to Korean Application NO. 10-2022-0156344, filed on Nov. 21, 2022, and priority to Korean Application NO. 10-2023-0156798, filed on Nov. 13, 2023, the contents of which are all hereby incorporated by reference herein in their entirety.

### TECHNICAL FIELD

The present disclosure relates to a method and a device for super-resolution of an image.

### BACKGROUND ART

The main purpose of the existing image processing technology is to maintain or improve quality which is best for human viewing. But, in a variety of future industrial fields, the main purpose of acquiring visible/invisible light image data is often a machine learning task such as image recognition, image partition, etc. and a higher level of machine learning task based thereon. In the future, it may be more useful to set a goal of image encoding/decoding to maintain or improve performance as much as possible when applying a machine learning-based task.

### DISCLOSURE

### Technical Problem

A task according to embodiments of the present disclosure proposes a method and a device for resolving the above-described problem.

### Technical Solution

A non-uniform super-resolution method, device, and recording medium of an image of the present disclosure may include an image separation unit which separates an input image into a high-quality region and a low-quality region based on a quality map image, an image quality conversion unit which acquires a converted high-quality region by converting image quality of the high-quality region, and a first image combination unit which combines the converted high-quality region and the low-quality region to transmit them to a super-resolution network.

In a non-uniform super-resolution method, device, and recording medium of an image of the present disclosure, the non-uniform super-resolution device of the image may further include a second image combination unit which selectively replaces a high-quality region of the image obtained from the super-resolution network with an existing high-quality region.

In a non-uniform super-resolution method, device, and recording medium of an image of the present disclosure, the first image combination unit may downsample a size of a combined image according to an input format of the super-resolution network.

In a non-uniform super-resolution method, device, and recording medium of an image of the present disclosure, conversion of the high-quality region of the image quality conversion unit may be performed by using any one method of downscaling, blurring or repacking.

A non-uniform super-resolution method, device, and recording medium of an image of the present disclosure may include converting, based on a method in which a quality map image is reflected on a non-uniform super-resolution network, a format of the quality map image, and acquiring, based on the converted quality map image, a restored image by inputting an input image of non-uniform quality to the non-uniform super-resolution network.

In a non-uniform super-resolution method, device, and recording medium of an image of the present disclosure, the method in which the quality map image is reflected may include a technique for masking a feature map, a technique for modulating differently per region, a technique for masking skip connection and a technique for using a spatial attention operation.

In a non-uniform super-resolution method, device, and recording medium of an image of the present disclosure, the technique for using the spatial attention operation may be a technique for allocating a high weight to a specific position according to mask information.

In a non-uniform super-resolution method, device, and recording medium of an image of the present disclosure, the converted quality map image may be a tensor having a size smaller than Q, not an image form.

In a non-uniform super-resolution method, device, and recording medium of an image of the present disclosure, the input image of non-uniform quality may be divided into a high-quality region and a low-quality region.

### Technical Effect

According to an embodiment of the present disclosure, image quality may be improved by performing super-resolution even for an image of non-uniform quality.

Quality information per region of an image may be utilized to modify the existing super-resolution network or apply it as it is, improving image quality.

When an image is preprocessed based on a region of interest as in an image encoding framework for machines, there is an advantage that perceptual image quality may be effectively improved by utilizing a proposed method.

### BRIEF DESCRIPTION OF DRAWINGS

FIG. 1 shows an anchor structure of an image encoding technology for machines.

FIG. 2 shows an example of a region of interest from a machine vision perspective.

FIG. 3 is an example of an image preprocessing method based on a region of interest.

FIGS. 4 to 8 show an image restoration method through non-uniform super-resolution according to the present disclosure.

### BEST MODE

As the present disclosure may make various changes and have several embodiments, specific embodiments will be illustrated in a drawing and described in detail. But, it is not intended to limit the present disclosure to a specific embodiment, and it should be understood that it includes all changes, equivalents or substitutes included in an idea and a technical scope for the present disclosure. A similar reference sign is used for a similar component while describing each drawing.

A term such as first, second, etc. may be used to describe various components, but the components should not be limited by the terms. The terms are used only to distinguish one component from other components. For example, without going beyond a scope of a right of the present disclosure, a first component may be referred to as a second component and similarly, a second component may be also referred to as a first component. A term, and/or, includes a combination of a plurality of relative entered items or any item of a plurality of relative entered items.

When a component is referred to as being “linked” or “connected” to other component, it should be understood that it may be directly linked or connected to other component, but other component may exist in the middle. On the other hand, when a component is referred to as being “directly linked” or “directly connected” to other component, it should be understood that other component does not exist in the middle.

As a term used in this application is only used to describe a specific embodiment, it is not intended to limit the present disclosure. Expression of the singular includes expression of the plural unless it clearly has a different meaning contextually. In this application, it should be understood that a term such as “include” or “have”, etc. is to designate the existence of features, numbers, steps, motions, components, parts or their combinations entered in a specification, but is not to exclude the existence or possibility of addition of one or more other features, numbers, steps, motions, components, parts or their combinations in advance.

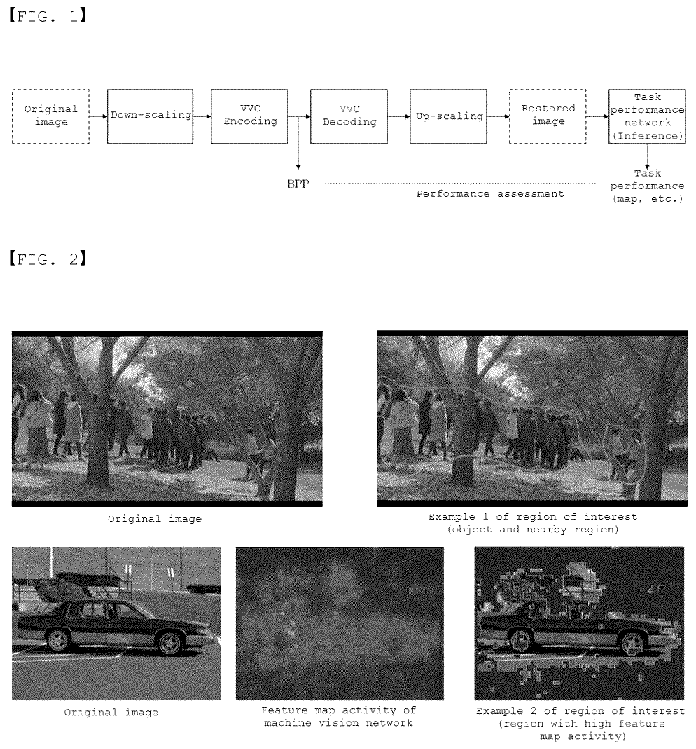

FIG. 1 shows an anchor structure of an image encoding technology for machines.

A traditional image encoding technology was developed with a focus on human perceptual image quality. Image encoding technologies such as HEVC (High Efficiency Video Coding) or VVC (Versatile Video Coding) were developed to achieve high compression efficiency simultaneously with reducing possible degradation in terms of image quality which is subjectively perceived by humans along with objective image quality indexes such as PSNR (Peak Signal-to-Noise Ratio), SSIM (Structural Similarity Index Measure), etc. However, as a subject of image consumption in various applications such as an autonomous vehicle, a drone, a smart surveillance camera, etc. has increasingly switched from humans to machines in recent days, an image encoding technology optimized for machine task performance, not human perceptual image quality as before, is being required. According to this necessity, a new image encoding method which may surpass an anchor as in FIG. 1 from a machine vision perspective is proposed.

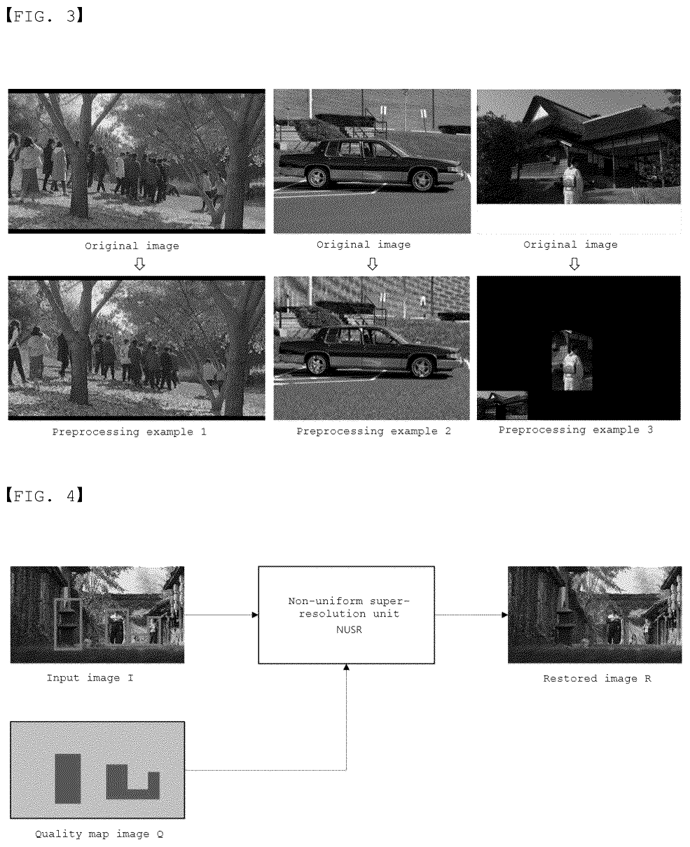

FIG. 2 shows an example of a region of interest from a machine vision perspective.

Among image encoding technologies for machines, a representative method under consideration is a method of preprocessing an image based on a region of interest in an image. Here, a region of interest refers to a region which is relatively important in performing a machine task. It may vary depending on a characteristic of an image, a type of a machine vision task, an applied application, etc., but a representative example includes (1) an object of interest and/or a nearby region thereof, (2) a region where a network feature map is activated with a high value, etc.

FIG. 3 is an example of an image preprocessing method based on a region of interest.

Image preprocessing based on a region of interest refers to an image processing technology which maintains high image quality of a region of interest and intentionally degrades image quality in the remaining regions excluding a region of interest to increase a compression rate without significantly degrading machine task performance. Here, an image processing method for degrading image quality of a region, not a region of interest, may include at least one of (1) downscaling, (2) blurring or (3) repacking.

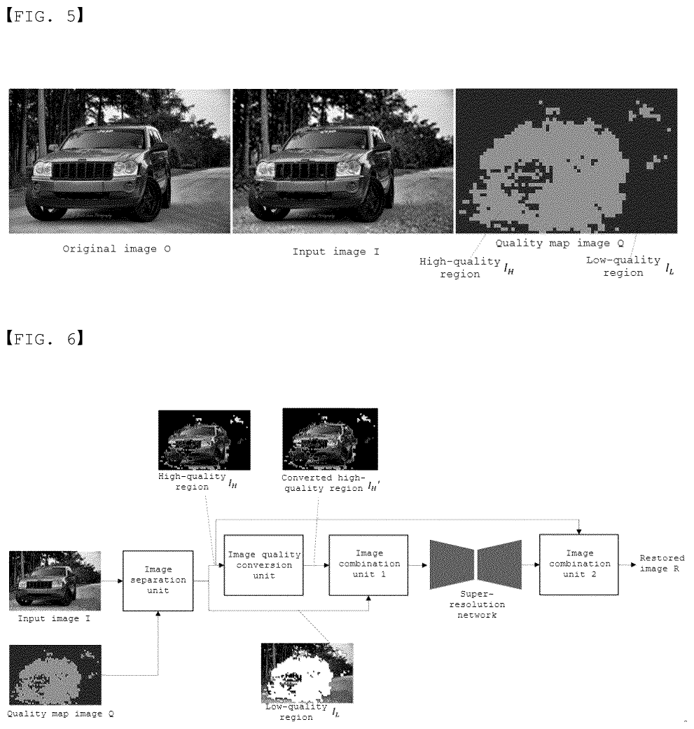

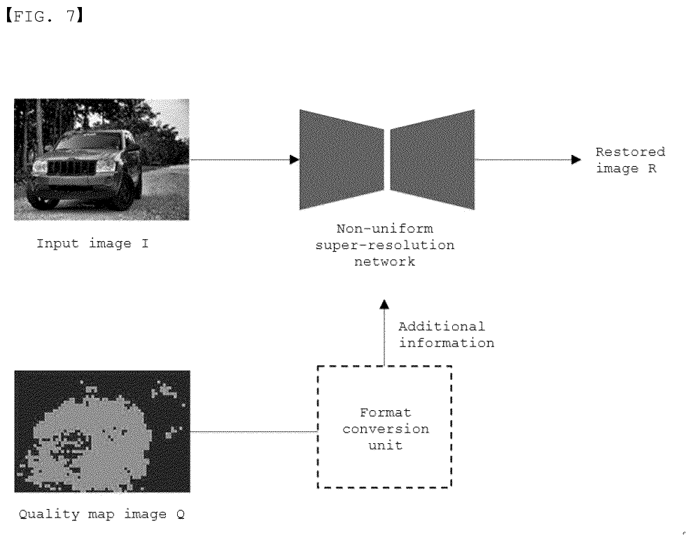

FIGS. 4 to 8 show an image restoration method through non-uniform super-resolution according to the present disclosure.

Input is input image I having non-uniform quality due to partial degradation in image quality and quality map image Q including quality information per region of a corresponding image. Restored image R with overall improved image quality may be obtained through Non-Uniform Super-Resolution (NUSR).

The present disclosure proposes two detailed methods for non-uniform super-resolution. A super-resolution model used in each method refers to a deep learning network learned to perform a general super-resolution problem and does not refer to specific one model. Here, a general super-resolution problem refers to a problem which aims to obtain a feature through a series of convolution operations, etc. from an image which has uniform quality, but has low resolution without image quality imbalance per region and to use this feature to obtain a high-resolution image of uniform image quality.

A first method is an image separation and recombination based method.

For a general super-resolution network, it is learned by assuming a low-resolution image with uniform image quality as input, so it is difficult to operate properly if an image preprocessed to have non-uniform quality is input as it is. Meanwhile, it may be difficult to properly perform super-resolution because semantic information of the entire image may not be obtained only with an image corresponding to a low-quality region. Accordingly, a method of separating a high-quality region of an input image, performing image quality conversion thereon to have a characteristic similar to a low-quality region and combining it to perform super-resolution is proposed. Hereinafter, it is assumed that an input image in the present disclosure is an image which was preprocessed to have non-uniform quality. But, it is not limited thereto, and of course, the present disclosure may be applied equally/similarly to an image which was preprocessed to have uniform quality.

In an image separation unit, information on quality map image Q may be used to separate input image I into high-quality region I_H and low-quality region I_L. Here, the separation of an input image may be performed by using a masking operation according to a type of a preprocessed image. Alternatively, if an image is packed as in preprocessing example 3 of FIG. 3, it may be separated into a high-quality region and a low-quality region through a simple separation operation.

An image quality conversion unit may receive high-quality region I_H and perform image quality conversion to have a characteristic similar to low-quality region I_L. Specifically, according to preprocessing performed on an input image, at least one of downscaling, blurring or repacking may be adaptively applied to separated high-quality region I_H. In an example, image quality conversion may be performed to have the same/similar characteristic as/to low-quality region by applying preprocessing performed on an input image equally to high-quality region I_H. Alternatively, image quality conversion may be performed to have the same/similar characteristic as/to low-quality region I_L by applying an additional preprocessing technique other than preprocessing performed on an input image to high-quality region I_H.

An image combination unit 1 may acquire low-resolution image l′ with uniform quality by combining high-quality region I_H′ and low-quality region I_L with converted image quality obtained from an image quality conversion unit. An acquired image may be resized according to an input format of a super-resolution network. For example, if a network was learned to receive an image in a size of W/2×H/2×3 and output an image in a size of W×H×3, a size of a combined image may be downsampled by half. Alternatively, if a network has a structure which performs deblurring or improves image quality without changing an image size itself, a combined image may be directly input to a super-resolution network without a process of adjusting a size. Alternatively, a combined image may be input to a network as it is without adjusting its size and a size of an image output from a network may be adjusted to correspond to a size or resolution of an input image.

An image combination unit 2 may replace a high-quality region of an improved image obtained from a network with the existing high-quality region I_H. Since an image obtained through inference of a super-resolution network may be more inaccurate than a high-quality region of the existing input image, the original is used, and if performance of a network is sufficient and image quality of a restored image is as good as the original, a corresponding process may be omitted.

A second method is a non-uniform super-resolution method based on additional information. Unlike a general super-resolution network, it is a network which is learned by assuming that quality of an image is non-uniform and an non-uniform image is input according to external information (e.g., a quality map image).

A network may perform super-resolution only for a low-quality region while using semantic information of a high-quality region by properly using information of Q internally. There may be various methods in which a quality map image is reflected on a network. For example, an intermediate feature map of a network may be (1) masked or (2) modulated differently per region. Alternatively, when (3) skip connection is masked or a network uses an attention module, it may be reflected on (4) a spatial attention operation.

In this case, according to a method in which a quality map image is reflected on a network, an input method may not be in a form of an image. For example, it may be a tensor with a size smaller than Q. When Q is not used as it is in a network, it may be converted into additional information in a proper form by selectively applying a format conversion unit.

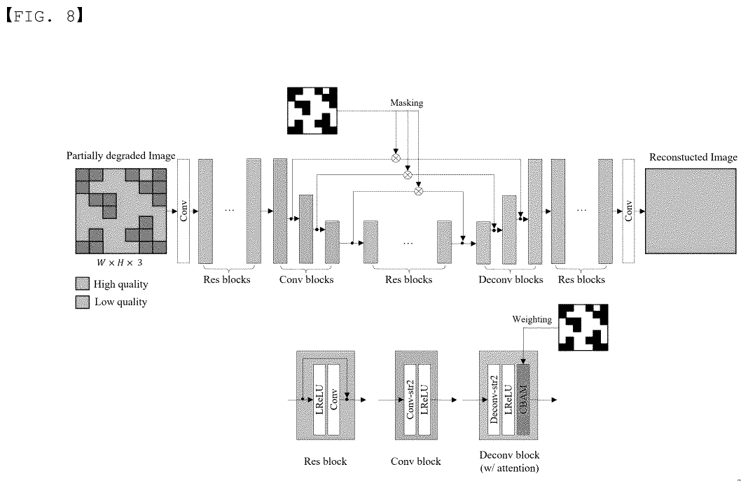

An embodiment of a method proposed through FIG. 7 is shown through FIG. 8. A proposal is not limited to one network structure, but assumes a U-Net-based specific network structure for convenience of a description. In a network formed in an encoder-decoder structure as in an embodiment, there may be skip connection which immediately hands over the same level of feature map to a decoder stage to concatenate or aggregate it in order to preserve local information of an encoder. In this case, only information of a high-quality region may be selectively handed over by applying quality map image-based masking to skip connection. In addition, when a network uses an attention module like a well-known CBAM (Convolutional Block Attention Module), it may be forced to allocate a high weight to a specific position according to mask information. Alternatively, it may be reflected in a method of performing a quality map image-based linear operation on a feature map at a specific position.

According to a type and a configuration of a super-resolution network, an application method may vary. When a quality difference per region of an image is known in advance and it may be used as additional information, it may be changed to perform non-uniform super-resolution by forcing it to perform a map-based differential operation on a super-resolution network designed for a general purpose.

The above-described disclosure is described based on a series of steps or flow charts, but it does not limit time series order of the present disclosure and if necessary, it may be performed at the same time or in different order. In addition, each component (e.g., a unit, a module, etc.) configuring a block diagram in the above-described disclosure may be implemented as a hardware device or software and a plurality of components may be combined and implemented as one hardware device or software. The above-described disclosure may be recorded in a computer readable recoding medium by being implemented in a form of a program instruction which may be performed by a variety of computer components. The computer readable recoding medium may include a program instruction, a data file, a data structure, etc. solely or in combination. An example of a computer readable recoding medium includes magnetic media such as a hard disk, a floppy disk and a magnetic tape, optical recording media such as a CD-ROM and a DVD, magneto-optical media such as a floptical disk and a hardware device which is specially configured to store and execute a program instruction such as ROM, RAM, a flash memory, etc. The hardware device may be configured to operate as at least one software module in order to perform processing according to the present disclosure and vice versa. A device according to the present disclosure may have a program instruction for storing or transmitting a bitstream generated by the above-described encoding method.

1. A non-uniform super-resolution device of an image, the device comprising:
an image separation unit which separates an input image into a high-quality region and a low-quality region based on a quality map image;
an image quality conversion unit which acquires a converted high-quality region by converting image quality of the high-quality region; and
a first image combination unit which combines the converted high-quality region and the low-quality region to transmit them to a super-resolution network.

2. The device of claim 1, wherein:
the non-uniform super-resolution device of the image further includes a second image combination unit which selectively replaces a high-quality region of the image obtained from the super-resolution network with an existing high-quality region.

3. The device of claim 1, wherein:
the first image combination unit downsamples a size of a combined image according to an input format of the super-resolution network.

4. The device of claim 1, wherein:
conversion of the high-quality region of the image quality conversion unit is performed by using any one method of downscaling, blurring or repacking.

5. A non-uniform super-resolution method of an image, the method comprising:
converting, based on a method in which a quality map image is reflected on a non-uniform super-resolution network, a format of the quality map image; and
acquiring, based on the converted quality map image, a restored image by inputting an input image of non-uniform quality to the non-uniform super-resolution network.

6. The method of claim 5, wherein:
the method in which the quality map image is reflected includes a technique for masking a feature map, a technique for modulating differently per region, a technique for masking skip connection and a technique for using a spatial attention operation.

7. The method of claim 6, wherein:
the technique for using the spatial attention operation is a technique for allocating a high weight to a specific position according to mask information.

8. The method of claim 5, wherein:
the converted quality map image is a tensor having a size smaller than Q, not an image form.

9. The method of claim 5, wherein:
the input image of non-uniform quality is divided into a high-quality region and a low-quality region.

10. A non-uniform super-resolution method of an image, the method comprising:
separating an input image into a high-quality region and a low-quality region based on a quality map image;
acquiring a converted high-quality region by converting image quality of the high-quality region; and
combining the converted high-quality region and the low-quality region to transmit them to a super-resolution network.

11. The method of claim 10, wherein:
the non-uniform super-resolution method of the image further includes selectively replacing a high-quality region of the image obtained from the super-resolution network with an existing high-quality region.

12. The method of claim 10, wherein:
a size of an image acquired by combining the converted high-quality region and the low-quality region is downsampled according to an input format of the super-resolution network.

13. The method of claim 10, wherein:
the converted high-quality region is acquired by using any one method of downscaling, blurring or repacking.

14. A computer readable recording medium storing a bitstream generated by a non-uniform super-resolution method of an image,
the non-uniform super-resolution method of the image comprising:
separating an input image into a high-quality region and a low-quality region based on a quality map image;
acquiring a converted high-quality region by converting image quality of the high-quality region; and
combining the converted high-quality region and the low-quality region to transmit them to a super-resolution network.
